(19) United States
(12) Patent Application Publication
(10) Pub. No.: US 2007/0180652 A1
(43) Pub. Date: Aug. 9, 2007

(54) Opening and closing device

(76) Inventor: Makoto Miyamoto, Fukui (JP)

Correspondence Address: WENDEROTH, LIND & PONACK L.L.P., 2033 K. STREET, NW, SUITE 800, WASHINGTON, DC, 20006, US

(21) Appl. No.: 11/652,090

(22) Filed: Jan. 11, 2007

(30) Foreign Application Priority Data
Jan. 25, 2006 (JP) 2006-015907
Mar. 10, 2006 (JP) 2006-065375

(51) Int. Cl. E05F 1/10

(52) U.S. Cl. 16/76

(57) ABSTRACT

An opening and closing device includes springs to be held by a fixed body and a movable body which are slidable relative to each other. Each of the springs has a plurality of turns, and an inner turn is smaller in diameter than the outer turns. At least one of the outer turns is overlapped with the inner turn. The plurality of turns enables the springs to produce a predetermined pushing force. The opening and closing device can prevent an increase in its height by the height of the inner turn, thereby being compact and ensuring precise operation.

### BACKGROUND OF THE INVENTION

1. Field of the Invention

The present invention relates to opening and closing devices used in various electronic devices such as mobile phones and personal computers.

2. Background Art

In recent years, as electronic devices such as mobile phones and personal computers are increasing in diversity and function, more and more such devices are designed to open and close the movable housing relative to the fixed housing. Therefore, opening and closing devices used in such electronic devices are also expected to be more compact and to ensure more precise operation. Japanese Patent Unexamined Publication No. 2003-110675, for example, discloses a mobile phone with an upper housing and a lower housing slidable relative to each other.

Such slide-type mobile electronic devices are also expected to be more compact and therefore required to have a more compact opening and closing device. However, the more compact it is, the more susceptible the opening and closing device is to scratches on its exposed surface while sliding. The scratches can spoil the appearance of the electronic devices.

### SUMMARY OF THE INVENTION

An object of the present invention, which has been devised to solve the aforementioned conventional problem, is to provide an opening and closing device capable of smooth operation without causing scratches.

In order to achieve the object, an aspect of the opening and closing device of the present invention includes springs to be held by a fixed body and a movable body which are slidable relative to each other. Each of the springs has a plurality of turns, and an inner turn is smaller in diameter than the outer turns. At least one of the outer turns is overlapped with the inner turn. The inner turn is connected to the inner circumference of the outer turns so that the opening and closing device can prevent an increase in its height by the height of the inner turn. As a result, the opening and closing device can be compact and ensure precise operation by maintaining the pushing force of the springs.

Another aspect of the opening and closing device of the present invention includes an isolation member for keeping the springs out of contact with the fixed body or the movable body. The turns of each spring do not come into direct contact with the movable body or the fixed body during the opening and closing operation. As a result, the movable body and the fixed body are protected from scratches so as to prevent the appearance from being disfigured and to ensure smooth opening and closing operation.

Additional objects and advantages of the present invention will be apparent from the following detailed description of preferred embodiments thereof, which are best understood with reference to the accompanying drawings.

### BRIEF DESCRIPTION OF THE DRAWINGS

FIG. 1 is a sectional view of an opening and closing device according to a first embodiment of the present invention.

FIG. 2 is an exploded perspective view of the opening and closing device according to the first embodiment.

FIG. 3 is a perspective view of a spring used in the opening and closing device according to the first embodiment.

FIG. 4 is a sectional view of an opening and closing device according to a second embodiment of the present invention.

FIG. 5 is an exploded perspective view of the opening and closing device according to the second embodiment.

FIG. 6 is a sectional view of an opening and closing device according to a third embodiment of the present invention.

FIG. 7 is an exploded perspective view of the opening and closing device according to the third embodiment.

FIG. 8 is a perspective view of a mobile phone.

FIG. 9 is a perspective view of a rear side of the mobile phone.

FIG. 10 is a sectional view of an early-model opening and closing device.

FIG. 11 is an exploded perspective view of the early-model opening and closing device.

FIG. 12 is a perspective view of a spring used in the early-model opening and closing device.

### DETAILED DESCRIPTION OF THE INVENTION

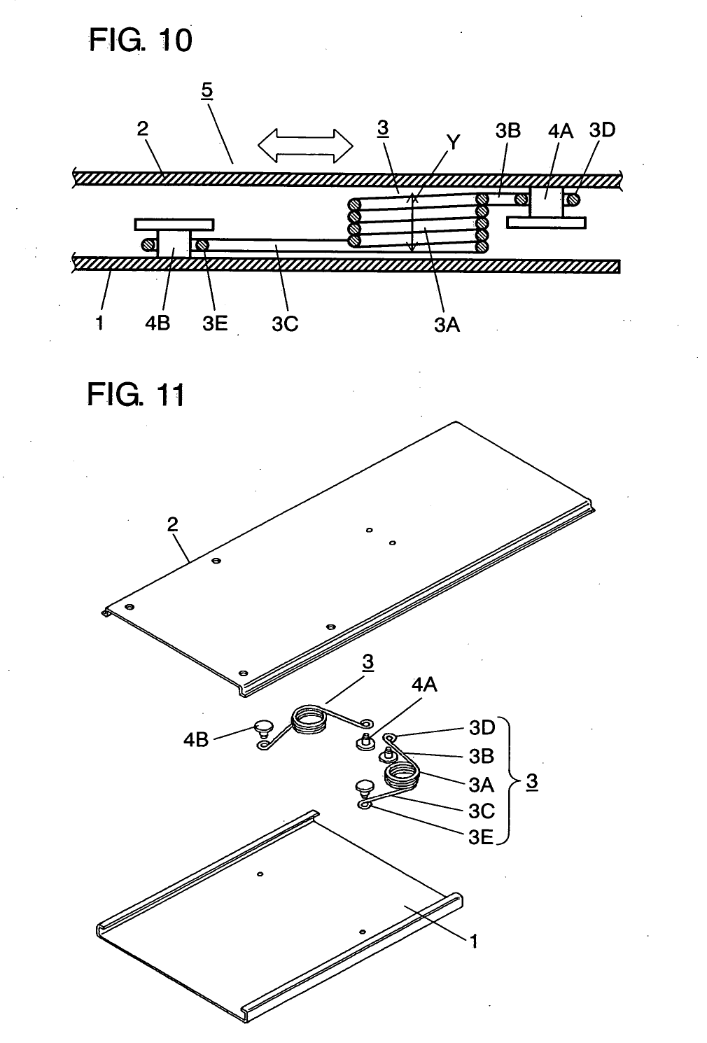

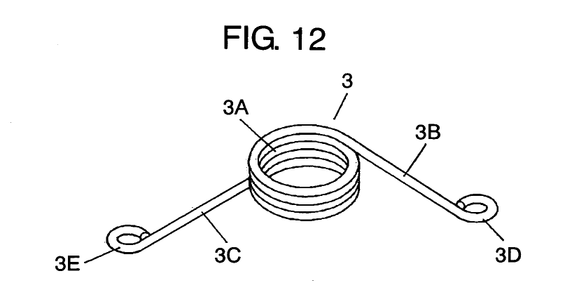

FIG. 10 is a sectional view of early-model opening and closing device 5; FIG. 11 is an exploded perspective view of opening and closing device 5; and FIG. 12 is a perspective view of a spring used in opening and closing device 5. Early-model opening and closing device 5 includes fixed body 1 nearly planer and bent at both ends, and movable body 2 also nearly planer and bent at both ends. Movable body 2 is mounted on the top surface of fixed body 1 so as to be slidable over fixed body 1 in the left-right direction.

Opening-closing device 5 further includes a pair of wire springs 3. Each spring 3 is provided at its center with a plurality of turns 3A that are coiled and laid upon one another equal in diameter. Each spring 3 has first arm 3B and second arm 3C respectively extending from the top end and the bottom end of turns 3A. First and second arms 3B and 3C have holding portion 3D and holding portion 3E, respectively at their ends.

Early-model opening and closing device 5 further includes a plurality of pins 4A and pins 4B fixed to movable body 2 and fixed body 1, respectively, by caulking or the like. The pair of springs 3 are symmetrically arranged in a slightly flexed state, and each spring 3 is held at holding portions 3D and 3E of its ends by pin 4A and pin 4B, respectively. The pair of springs 3 thus push movable body 2 against fixed body 1 in the left or right direction.

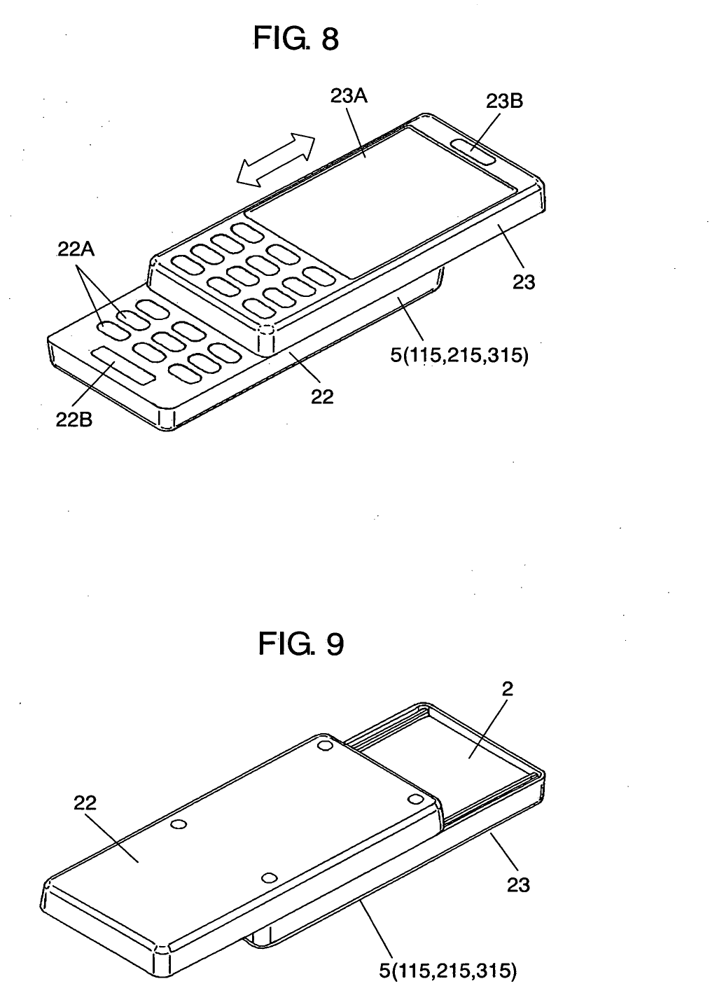

An example where opening and closing device 5 thus structured is used in a mobile phone is shown in FIG. 8. Fixed body 1 is attached to fixed housing 22, which is provided on its top surface with operating part 22A having a plurality of keys and voice input portion 22B such as a microphone. On the other hand, movable body 2 is attached to movable housing 23, which is provided on its top surface with display portion 23A such as a liquid crystal display and voice output portion 23B such as a speaker. Using opening and closing device 5 provides an electronic device in which movable housing 23 is slidable relative to fixed housing 22 in the parallel direction.

In FIG. 8, the pair of springs 3 push movable body 2 to the right from fixed body 1. In this condition, movable housing 23 to which movable body 2 has been attached is pushed to the right from fixed housing 22. As a result, movable housing 23 is held open with both voice input portion 22B and voice output portion 23B exposed. The user can use the phone with movable housing 23 open.

When the user slides movable housing 23 in the open state to the left by hand, movable body 2 attached to movable housing 23 moves to the left. When movable body 2 moves to the position at which holding portions 3D held by movable body 2 by pins 4A reaches beyond holding portions. 3E held by fixed body 1 by pins 4B, the pair of springs 3 turn around. Springs 3 thus turned around push movable body 2 in the opposite or left direction. Pushing movable body 2 to the left in this manner allows movable housing 23 to be laid on fixed housing 22, or in other words, allows opening and closing device 5 to be slid closed.

Thus, when the user slides movable body 2 attached to movable housing 23 to the left or right by hand so as to cause springs 3 to push movable body 2 to the left or right, movable housing 23 can be slid opened or closed relative to fixed housing 22.

Instead of springs 3 provided at their center with a plurality of turns coiled and laid upon one another, springs with an approximately U-shaped center could be used. However, in order to allow the user to slide open and close movable body 2 without undue force and simultaneously to securely keep movable body 2 at the position slid leftwardly or rightwardly from fixed body 1, the springs are required to exert a predetermined pushing force.

Furthermore, the overall size of the springs cannot be made very large because it is used in comparatively small devices such as mobile phones. Therefore, in order to easily achieve the aforementioned predetermined pushing force, early-model opening and closing device 5 uses springs 3 provided at their center with the plurality of turns 3A coiled and laid upon one another equal in diameter.

However, springs 3 in early-model opening and closing device 5 have a height corresponding to the number of turns 3A that are coiled and laid upon one another equal in diameter at the center of springs 3. This results in an increase in the total height of opening and closing device 5, thereby preventing miniaturization.

Primary-mode opening and closing device 5 has another problem as follows. When the user slides open or close movable body 2 relative to fixed body 1 in the left or right direction so as to cause springs 3 to bend and push movable body 2 in the left or right direction, turns 3A and first and second arms 3B and 3C are subjected to a predetermined force. As shown by the solid-line arrow Y in FIG. 10, the predetermined force deforms turns 3A and first and second arms 3B and 3C in upward or downward direction. First and second arms 3B and 3C thus deformed come into contact with the surfaces of movable body 2 and fixed body 1, respectively, the surfaces being opposite to first and second arms 3B and 3C, respectively. Since first and second arms 3B and 3C are slid in the left-right direction while scratching the surfaces of movable body 2 and fixed body 1, these surfaces have scratches.

As shown in the perspective view of FIG. 9, if the bottom surface of movable body 2 corresponding to the rear surface of movable housing 23 has scratches, it can be seen from outside when opening and closing device 5 is slid open. The scratches not only spoil the appearance, but also cause movable housing 23 to slide open and close jerkily, thereby preventing smooth operation.

Embodiments of the present invention will be described specifically with reference to drawings as follows.

### First Embodiment

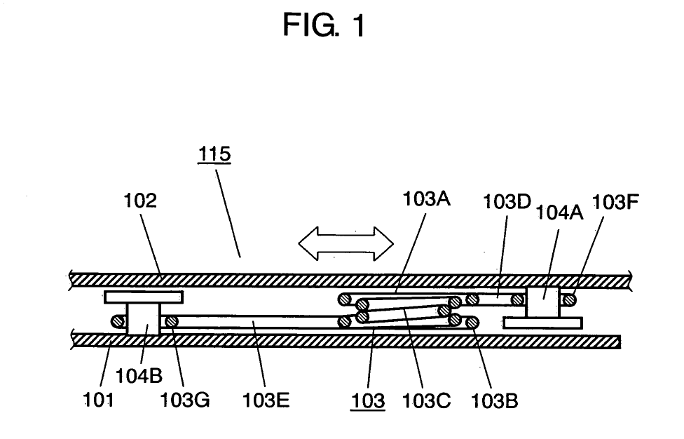

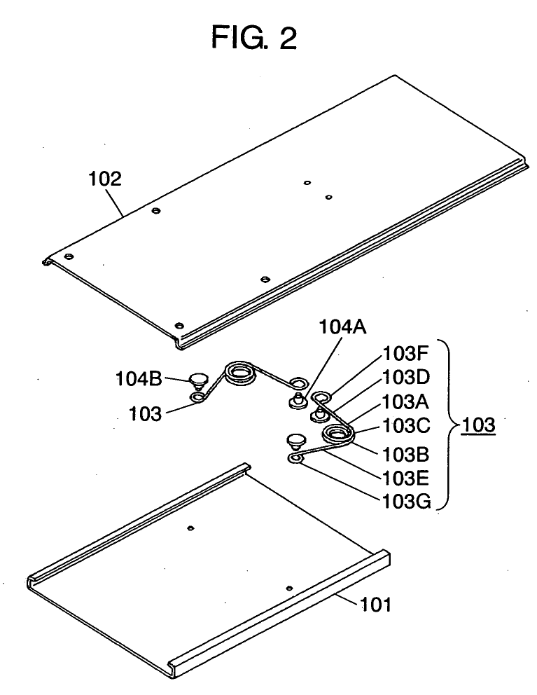

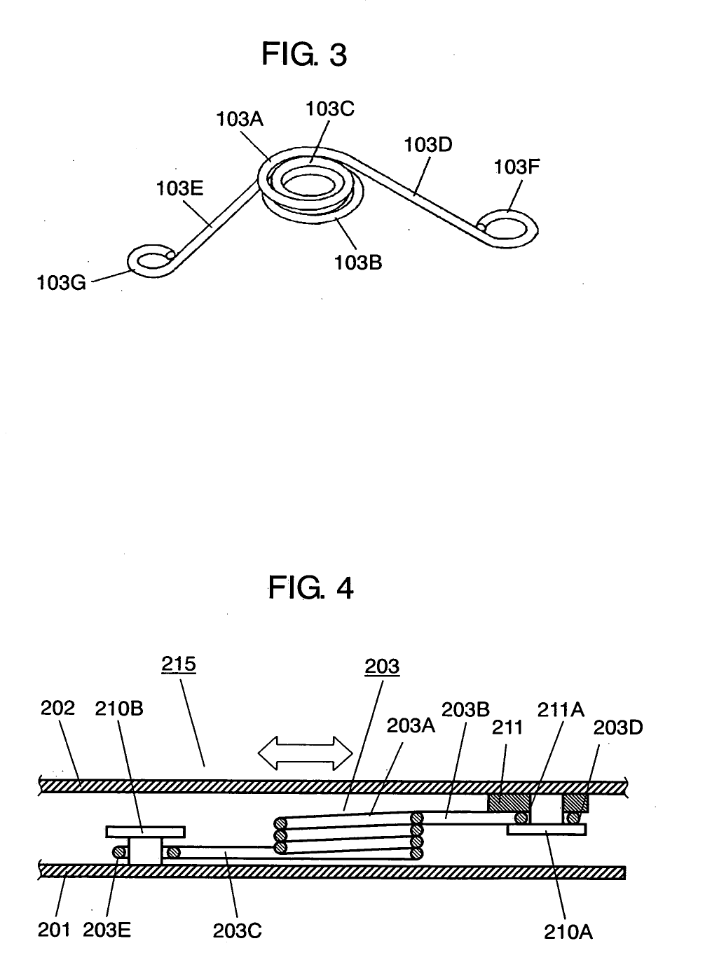

FIG. 1 is a sectional view of opening and closing device 115 according to a first embodiment of the present invention. FIG. 2 is an exploded perspective view of opening and closing device 115, and FIG. 3 is a perspective view of a spring used in opening and closing device 115. Opening-closing device 115 includes fixed body 101 and movable body 102 that are made of a metal such as steel or copper alloy. Each of fixed body 101 and movable body 102 is nearly planer and bent at both ends. Movable body 102 is mounted on fixed body 101 so as to be slidable over fixed body 101 in the left-right direction.

Opening-closing device 115 further includes a pair of wire springs 103 made of steel or copper alloy. As shown in FIG. 3, each spring 103 is coiled to have first turn 103A on its top and second turn 103B on its bottom. Each spring 103 further has a plurality of inner turns 103C between first turn 103A and second turn 103B. Inner turns 103C are coiled with a smaller diameter than first and second turns 103A and 103B so as to be connected to the inner circumference of first and second turns 103A and 103B. Each of first turn 103A, second turn 103B, and inner turns 103C is shown as a single turn in FIG. 3; however, each may consist of a plurality of turns. Note that first turn 103A, second turn 103B, and inner turns 103C may hereinafter collectively be referred to as “turns”.

Each spring 103 has first arm 103D in the upper portion extending from first turn 103A and second arm 103E in the lower portion extending from second turn 103B. First and second arms 103D and 103E have first holding portion 103F and second holding portion 103G, respectively, at their ends. First and second arms 103D and 103E may be curved, but preferably nearly linear.

Opening-closing device 115 further includes a plurality of pins 104A and pins 104B fixed to movable body 102 and fixed body 101, respectively, by caulking or the like. The pair of springs 103 are symmetrically arranged in a slightly flexed state, and each spring 103 is held at first and second holding portions 103F and 103G of its ends by pin 104A and pin 104B, respectively. The pair of springs 103 thus push movable body 102 against fixed body 101 in the left-right direction.

As described above, each spring 103 has the plurality of inner turns 103C, which are connected to first and second turns 103A and 103B and have an outer diameter smaller than the inner diameter of first and second turns 103A and 103B. Furthermore, inner turns 103C with the smaller outer diameter are connected to the inner circumference of first and second turns 103A and 103B in such a manner as to be overlapped with at least one of first and second turns 103A and 103B in the height direction of springs 103. As a result, the height of each spring 103 can be reduced by the height of inner turns 103C compared with a spring formed of a plurality of turns laid upon one another equal in diameter. This results in a reduction in the overall size of opening and closing device 115. Alternatively, the outer diameter of inner turns 103C may be made smaller than the outer diameter and larger than the inner diameter of first and second turns 103A and 103B. In this case, however, the effect of reducing the height of springs 103 is small.

Furthermore, providing the plurality of coiled inner turns 103C between first and second turns 103A and 103B in such a manner as to be connected thereto can control the number and diameter of the turns. This facilitates for spring 103 to exert the predetermined pushing force.

Opening-closing device 115 thus structured can be applied, for example, to mobile phones. As shown in FIG. 8, fixed body 101 is attached to fixed housing 22, which is provided on its top surface with operating part 22A having a plurality of keys and voice input portion 22B such as a microphone. On the other hand, movable body 102 is attached to movable housing 23, which is provided on its top surface with display portion 23A such as a liquid crystal display and voice output portion 23B such as a speaker. Using opening and closing device 115 provides an electronic device in which movable housing 23 slides relative to fixed housing 22 in the parallel direction.

As shown in FIG. 1, in opening and closing device 115 of the present embodiment, when the pair of springs 103 push movable body 102 to the right from fixed body 101, movable housing 23 to which movable body 102 has been attached is pushed to the right from fixed housing 22. In this condition, movable housing 23 is held open with both voice input portion 22B and voice output portion 23B exposed, allowing the user to use the mobile phone. When movable housing 23 is held open, first arm 103D and second arm 103E are arranged to form a predetermined angle with the turns therebetween.

When the user slides movable housing 23 in the open state to the left by hand, movable body 102 attached to movable housing 23 moves to the left. When movable body 102 moves to the position at which first holding portions 103F held by movable body 102 by pins 104A reaches beyond second holding portions 103G held by fixed body 101 by pins 104B, the pair of springs 103 turn around second holding portions 103G and pushing direction of springs 103 is reversed from the right direction to the left direction. As spring 103 now pushes movable body 102 to the left, movable housing 23 comes to be laid on fixed housing 22, or in other words, allowing opening and closing device 115 to be slid closed. In the present embodiment, spring 103 is held so that an angle between first arm 103D and second arm 103E is widened.

Thus, when the user slides movable body 102 attached to movable housing 23 to the left or right by hand so as to cause springs 103 to push movable body 102 to the left or right, movable housing 23 can be slid opened or closed relative to fixed housing 22.

As described above, springs 103 for pushing movable body 102 to the left or right each have the plurality of coiled inner turns 103C connected to first and second turns 103A and 103B. This structure can control the number and diameter of the turns to make springs 103 exert the predetermined pushing force in the opening and closing operation, ensuring movable body 102 to move to the left or right and be held there.

Furthermore, since the plurality of inner turns 103C are connected to the inner circumference of first and second turns 103A and 103B, the height of springs 103 can be prevented from being increased by the height of inner turns 103C. This results in a reduction in the overall size of opening and closing device 115.

As described hereinbefore, in opening and closing device 115 according to the present embodiment, each spring 103 is provided at its center with first turn 103A, second turn 103B, and inner turns 103C having a smaller diameter than first and second turns 103A and 103B. Each spring 103 is further provided with first and second arms 103D and 103E extending from the turns, and first and second arms 103D and 103E are held at their ends to movable body 102 and fixed body 101, respectively. This structure allows the plurality of turns to provide springs 103 with the predetermined pushing force, and also prevents the height of springs 103 from being increased by the height of inner turns 103C. This can provide an opening and closing device that is compact and ensures precise operation.

### Second Embodiment

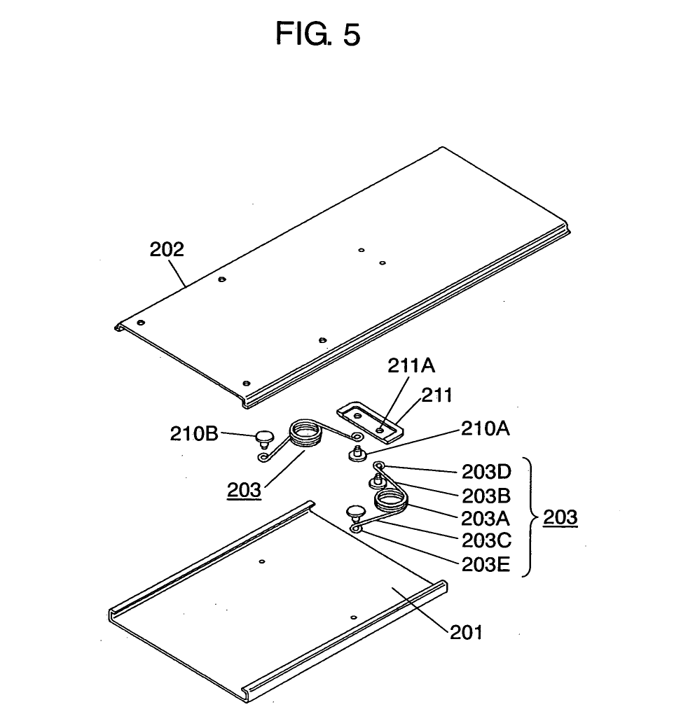

FIG. 4 is a sectional view of opening and closing device 215 according to a second embodiment of the present invention, and FIG. 5 is an exploded perspective view of opening and closing device 215.

Opening-closing device 215 includes fixed body 201 and movable body 202 that are made of a metal such as steel or copper alloy. Each of fixed body 201 and movable body 202 is nearly planer and bent at both ends. Movable body 202 is mounted on the top surface of fixed body 201 so as to be slidable over fixed body 201 in the left-right direction.

Opening-closing device 215 includes a pair of wire springs 203 made of steel or copper alloy and bent in the center. Each spring 203 is provided at its center with a plurality of turns 203A coiled and laid upon one another. Each spring 203 has first arm 203B extending from its top end and second arm 203C extended at its bottom end. First and second arms 203B and 203C have nearly annular first holding portion 203D and nearly annular second holding portion 203E, respectively, at their ends.

Opening-closing device 215 further includes a plurality of pins 210A and pins 210B fixed to movable body 202 and fixed body 201, respectively, by caulking or the like. The pair of springs 203 are symmetrically arranged in a slightly flexed state, and each spring 203 is held at first and second holding portions 203D and 203E of its ends by pin 210A and pin 210B, respectively. The pair of springs 203 thus push movable body 202 against fixed body 201 in the left or right direction.

Opening-closing device 215 further includes spacer 211, which is nearly planer and made of resin such as polyoxymethylene. Spacer 211 is disposed between the bottom surface of movable body 202 and first holding portions 203D, or in other words, between movable body 202 and first arms 203B. Each pin 210A penetrates through first holding portion 203D and hole 211A formed in spacer 211 so as to be fixed to movable body 202.

As shown in FIG. 8, opening and closing device 215 thus structured can be used in a mobile phone. In FIG. 8, fixed body 201 is attached to fixed housing 22, which is provided on its top surface with operating part 22A having a plurality of keys and voice input portion 22B such as a microphone. On the other hand, movable body 202 is attached to movable housing 23, which is provided on its top surface with display portion 23A such as a liquid crystal display and voice output portion 23B such as a speaker. In the mobile phone with opening and closing device 215, movable housing 23 can be moved relative to fixed housing 22 in the parallel direction.

FIGS. 4 and 8 show a state where, in the mobile phone with opening and closing device 215, the pair of springs 203 push movable body 202 to the right from fixed body 201. In this condition, movable housing 23 to which movable body 202 has been attached is pushed to move to the right from fixed housing 22. As a result, movable housing 23 is held open with both voice input portion 22B and voice output portion 23B exposed.

When the user slides movable housing 23 in the open state to the left by hand, movable body 202 attached to movable housing 23 moves to the left. When movable body 202 moves to the position at which first holding portions 203D held by movable body 202 by pins 210A reaches beyond second holding portions 203E held by fixed body 201 by pins 210B, the pair of springs 203 turn around. Springs 203 thus turned around push movable body 202 to the left. Pushing movable body 202 to the left in this manner allows movable housing 23 to be laid on fixed housing 22, or in other words, allows opening and closing device 215 to be slid closed.

Thus, when the user slides movable body 202 attached to movable housing 23 to the left or right by hand, springs 203 push movable body 202 to the left or right, thereby allowing movable housing 23 to be slid open or closed relative to fixed housing 22.

When movable body 202 is moved to the left or right relative to fixed body 201, turns 203A and first and second arms 203B of each spring 203 that pushes movable body 202 to the left or right are subjected to a force and deformed in upward or downward direction. According to the present embodiment, spacer 211 disposed between movable body 202 and first holding portions 203D can prevent turns 203A or first arm 203B of each spring 203 from coming into contact with the bottom surface of movable body 202.

In other words, spacer 211 disposed between movable body 202 and first holding portions 203D ensures a predetermined clearance between turns 203A or first arm 203B of each spring 203 and the bottom surface of movable body 202. The clearance prevents turns 203A or first arm 203B of each spring 203 from coming into contact with the bottom surface of movable body 202 and scratching the surface even if turns 203A or first arm 203B is deformed in upward or downward direction.

Therefore, the bottom surface of movable body 202 can be protected from scratches due to springs 203 in the opening and closing operation. The bottom surface can be seen from the rear side as shown in the perspective view of FIG. 9 when the mobile phone is slid open. As a result, the mobile phone is prevented from having a disfigured appearance, and opening and closing device 215 is prevented from causing jerky operation.

In addition to the disposition of spacer 211 between first holding portions 203D and movable body 202, predetermined clearances are formed between spacer 211 and movable body 202 and between first holding portions 203D and pins 210A. These clearances enable first arms 203B to move smoothly to ensure the operation of opening and closing device 215.

Thus, in opening and closing device 215 according to the present embodiment, predetermined clearances are formed by spacer 211 between turns 203A or first arm 203B of each spring 203 and the bottom surface of movable body 202 so as to prevent their contact with each other during the opening and closing operation. This provides an opening and closing device ensuring smooth operation, while preventing the appearance from being disfigured by scratches during the opening and closing operations.

In the aforementioned description, conventional member 211 is disposed exclusively between first holding portions 203D and movable body 202. On the other hand, in a case where an electronic device is designed to expose fixed body 201, spacer 211 can be disposed between second holding portions 203E and fixed body 201. It is alternatively possible to dispose spacer 211 both between first holding portions 203D and movable body 202 and between second holding portions 203E and fixed body 201.

A leaf spring may be used instead of the coil spring in the second embodiment.

### Third Embodiment

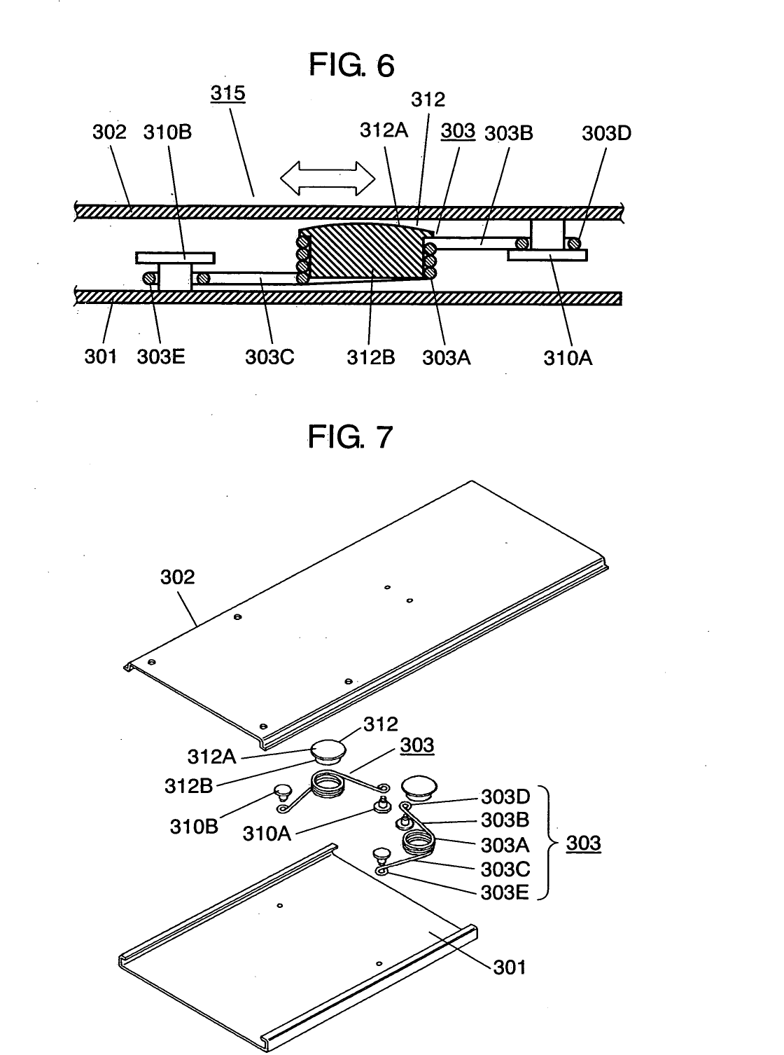

FIG. 6 is a sectional view of opening and closing device 315 according to a third embodiment of the present invention, and FIG. 7 is an exploded perspective view of opening and closing device 315. The same components as those according to the first and second embodiments will be referred to with the same numerals and symbols as those according to the first and second embodiments, and not described in detail again.

In opening and closing device 315, movable body 302 is mounted on nearly planer fixed body 301 so as to be slid relative to fixed body 301 in the left-right direction.

A pair of springs 303 each includes first arm 303B and second arm 303C extending from a plurality of turns 303A. First and second arms 303B and 303C have first holding portion 303D and second holding portion 303E, respectively, which are held by fixed body 301 and movable body 302 by pin 310A and pin 310B, respectively. The pair of springs 303 thus push movable body 302 against fixed body 301 in the left-right direction.

Opening-closing device 315 includes protective members 312 made of resin such as polyoxymethylene. Turns 303A are provided with nearly disk-shaped protective portion 312A on its top and with nearly cylindrical holding portion 312B on its bottom. Holding portion 312B is press-fit into turns 303A of each spring 303.

Protective portion 312A of protective member 312 has a larger outer diameter than turns 303A and covers the top surface of turns 303A in such a manner as to be opposed to the bottom surface of movable body 302.

As shown in FIG. 8, opening and closing device 315 thus structured can be used in a mobile phone. Fixed body 301 and movable body 302 are attached to fixed housing 22 and movable housing 23, respectively. Opening-closing device 315 allows movable housing 23 to be slidable relative to fixed housing 22 in the parallel direction. When the user slides movable body 302 attached to movable housing 23 to the left or right by hand so as to cause springs 303 to push movable body 302 to the left or right, movable housing 23 can be slid open or closed-relative to fixed housing 22.

During the opening and closing operation, a force is applied to turns 303A, first arm 303B in the upper portion, and second arm 303C in the lower portion of each spring 303, thereby deforming them in upward or downward direction. Since the top surface of turns 303A of each spring 303 is covered with protective portion 312A, even if turns 303A are deformed in upward direction, soft protective portion 312A made of resin just comes into contact with the bottom surface of movable body 302 made of a metal plate. In other words, none of turns 303A and first arm 303B of each spring 303, which is made of metal wire, comes into direct contact with the bottom surface of movable body 302.

Thus, covering the top surface of turns 303A of each spring 303 with protective portion 312A of protective member 312 can protect the bottom surface of movable body 302 from scratches.

Therefore, using opening and closing device 315 according to the present embodiment can protect the bottom surface of movable body 302 from scratches due to springs 303 in the opening and closing operation. The bottom surface can be seen from the rear side as shown in the perspective view of FIG. 9 when the mobile phone is slid open. As a result, the mobile phone is prevented from having a disfigured appearance, and opening and closing device 315 is prevented from causing jerky operation.

Press-fitting nearly cylindrical holding portion 312B of protective member 312 into turns 303A of each spring 303 allows protective member 312 to be attached to each spring 303 by a single operation. This can simplify the assembly of opening and closing device 315 and also prevent protective member 312 from accidentally becoming detached from turns 303A during the opening and closing operation.

The aforementioned description shows an example where the top surface of turns 303A of each spring 303 on the movable body 302 side is covered with protective portion 312A of protective member 312. However, it is alternatively possible to cover the bottom surface of turns 303A of each spring 303 on the fixed body 301 side by press-fitting protective portion 312A of protective member 312 from below turns 303A.

It is further alternatively possible that two protective members 312 having nearly cylindrical holding portions 312B are formed and press-fit into the top and bottom surfaces of turns 303A of each spring 303 so as to cover these surfaces, thereby protecting both the bottom surface of movable body 302 and the top surface of fixed body 301 from scratches.

In the aforementioned description, protective portion 312A of each protective member 312 is designed as nearly disk-shaped so as to cover the entire surface of turns 303A of each spring 303. Alternatively, the present invention can be implemented by designing each protective portion 312A like the letter I, letter X, or a rectangle in a top view so as to cover only a predetermined surface of turns 303A.

Note that spacer 211 and protective members 312 may be collectively referred to as an “isolation member”. Spacer 211 of the second embodiment could be used with springs 103 of the first embodiment. Protective members 312 of the third embodiment could be also used with springs 103 of the first embodiment. Such combinations can provide both miniaturization and scratch protection at the same time for the opening and closing device.

It will be obvious to those skilled in the art that various changes may be made in the above-described embodiments of the present invention. However, the scope on the present invention should be determined by the following claims.

What is claimed is:

1. An opening and closing device comprising a planer fixed body, a planer movable body movable relative to the fixed body, and a spring,
wherein the spring includes a plurality of turns, a first arm and a second arm, the first arm and the second arm extending from both ends of the turns;
the first arm is attached to the movable body;
the second arm is attached to the fixed body;
a direction where the spring pushes the movable body is reversed when the movable body moves relative to the fixed body and
the turns include an inner turn having a smaller diameter than outer turns.

2. The opening and closing device of claim 1, wherein the turns includes:
a first turn leading to the first arm;
a second turn leading to the second arm; and
an inner turn between the first turn and the second turn;
the inner turn has an outer diameter smaller than an inner diameter of at least one of the first turn and the second turn; and
the inner turn is overlapped with at least one of the first turn and the second turn in a height direction.

3. An opening and closing device comprising a nearly planer fixed body, a nearly planer movable body movable relative to the fixed body, and a spring,
wherein the spring includes a plurality of turns, a first arm and a second arm, the first arm and the second arm extending from both ends of the turns;
the first arm is attached to the movable body;
the second arm is attached to the fixed body;
a direction where the spring pushes the movable body is reversed when the movable body moves relative to the fixed body and
the opening and closing device further comprising:
an isolation member for keeping at least one of the first arm and the second arm out of contact with one of the movable body and the fixed body.

4. The opening and closing device of claim 3, wherein the isolation member is a planer spacer, the spacer being at least one of between the first arm and the movable body and between the second arm and the fixed body.

5. The opening and closing device of claim 3, wherein the isolation member is a protective member attached to the turns, the protective member including:
a disk portion covering at least one surface of the turns; and
a cylindrical holding portion protruding from the disk portion, and
the holding portion is held by the turns.

6. The opening and closing device of claim 3, wherein the turns include an inner turn having a smaller diameter than outer turns.

7. The opening and closing device of claim 3, wherein the turns include:
a first turn leading to the first arm;
a second turn leading to the second arm; and
an inner turn between the first turn and the second turn;
the inner turn has an outer diameter smaller than an inner diameter of one of the first turn and the second turn; and
the inner turn is overlapped with at least one of the first turn and the second turn in a height direction.
